(19) United States
(12) Patent Application Publication
(10) Pub. No.: US 2014/0139440 A1
(43) Pub. Date: May 22, 2014

(54) TOUCH OPERATION PROCESSING METHOD AND DEVICE

(71) Applicant: Samsung Electronics Co., Ltd., Gyeonggi-do (KR)

(72) Inventors: Xiaoyan QU, Beijing (CN); Chaojin XU, Beijing (CN)

(73) Assignee: Samsung Electronics Co., Ltd., Gyeonggi-do (KR)

(21) Appl. No.: 14/079,991

(22) Filed: Nov. 14, 2013

(30) Foreign Application Priority Data
Nov. 19, 2012 (CN) 201210468525.9

(51) Int. Cl. G06F 3/041; G06F 3/01; G06F 3/0488

(52) U.S. Cl. CPC G06F 3/041; G06F 3/04883; G06F 3/018
USPC 345/169; 345/173

(57) ABSTRACT

A touch operation processing method is provided, which comprises the following steps: a terminal device detects a floating position of an operation object in a floating sensing area outside of a screen, and maps the floating position to a corresponding position on the screen; based on the type of an area where the corresponding position locates, the terminal device detects a floating touch operation of the operation object by adopting a way corresponding to the type of the area, and makes a response to the floating touch operation accordingly. Another aspect of the embodiments of the present invention provides a terminal device. The above solution proposed by the present invention provides a variety of choices for the user input operation by introducing floating touch technique during the user input. Further, according to the technical solution proposed by the present invention, manipulation functions corresponding to the floating touch operations can be defined according to the user's requirements, which allows the user input operation to be more efficient and convenient and brings a kind of totally new edit and input experience to the user.

### CLAIM OF PRIORITY

This application claims priority under 35 U.S.C. §119(a) to a Chinese Patent Application filed in the State Intellectual Property Office on Nov. 19, 2012 and assigned Serial No. 201210468525.9, the content of which is herein incorporated by reference.

### BACKGROUND

1. Technical Field

The present disclosure relates to the field of terminal devices, and particularly relates to a touch operation processing method and device.

2. Description of the Related Art

In recent years, with the rapid development of electronic industry and communication technology, new services that are based on data, voice, and video are growing exponentially. The rapid development of microelectronic technology and computer software and hardware technology enables the terminal devices to process more complex tasks and provides personalization. In addition, users demand more flexible, smart and multifunctional devices to address their needs.

Currently, an input method for use in terminal devices gradually changed from original physical keys into virtual keys known as soft keys or soft keyboard. However, the currently available input modes are monotonous and the user experience is insufficient. Further, since some terminals have a limited screen size, when a user makes an input, false “click” operation can occur easily.

### SUMMARY

The present invention provides a floating touch scheme which is a highly efficient and yields a convenient terminal input solution.

The present invention proposes a touch operation processing method for use in a portable terminal which includes: detecting a floating position of an object near a floating sensing area of a screen; mapping the detected floating position to a corresponding position on the screen; and adjusting an appearance of at least one key displayed on the screen in response to the operation object nears thereto.

Another aspect of the embodiments of the present invention further proposes a terminal device for providing a touch operation which includes: a touch screen configured to detect a floating operation of an object near a floating sensing area of the touch screen and map the detected floating position to a corresponding position thereon; and a controller controlling the touch screen to adjust at least one key displayed on the screen in response to the operation object nears thereto.

The above solution proposed by the present invention provides a variety of choices for the user input operation. In addition, according to the technical solution proposed by the present invention, manipulation functions corresponding to the floating touch operations can be defined according to the user's requirements, which allows the user input operation to be more efficient and convenient and brings a kind of totally new edit and input experience to the user. The present invention proposes the above solution with few modifications to conventional systems, which will not affect the system compatibility and easy and highly efficient to realize.

The additional aspects and advantages of the present invention will be provided in the following description, which will be apparent from the following descriptions or got from the practice of the present invention.

### BRIEF DESCRIPTION OF THE DRAWINGS

The foregoing and/or additional aspects and advantages of the invention will be apparent and easily understood from the following description of embodiments in conjunction with the accompanying drawings, in which:

FIG. 1 is a flowchart showing the touch operation processing method according to the embodiment of the present invention;

FIG. 2 is a schematic diagram showing interactions of entities under input mode;

FIG. 3 is a control schematic diagram showing locally adaptively adjusting the size of the input method keyboard by floating touch;

FIG. 4 is a control schematic diagram showing expanding and displaying multiple characters on a single key.

FIG. 5 is a schematic diagram showing interactions of entities under edit mode;

FIG. 6 is customizing different functions corresponding to floating touch operations according to a user's requirements;

FIG. 7 is a schematic diagram showing an edit processing realized by the floating touch; and

FIG. 8 is a schematic diagram showing the structure of a terminal device.

### DETAILED DESCRIPTION

Embodiments of the present invention will be described in detail hereafter. The examples of the embodiments will be illustrated by the accompanying drawings, wherein similar or same numeral symbols indicate similar or same elements or elements with same or similar functions. The embodiments described with reference to the drawings are intended to explain the present invention and should not be construed as limitation to the present invention.

It will be understood by the skilled in the art that the singular forms “a”, “an”, “the”, and “said” may be intended to include plural forms as well, unless the context clearly indicates otherwise. It should be further understood that the terms “comprises/comprising” used in this specification specify the presence of stated features, integers, steps, operations, elements, and/or components, but do not preclude the presence or addition of one or more other features, integers, steps, operations, elements, components, and/or groups thereof. It should be understood that when a component is referred to as being “connected to” or “coupled to” another component, it can be directly connected or coupled to the other element or intervening elements may be present. In addition, the “connected to” or “coupled to” may also refer to wireless connection or couple. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Those skilled in the art will understand that the term “terminal” used herein compasses not only devices with a wireless signal receiver having no emission capability but also devices with receiving and emitting hardware capable of carrying out bidirectional communication over the two-way communication link. This kind of devices may include a cellular or other communication device with or without a multi-line display; a personal communication system (PCS) with combined functionalities of voice and data processing, facsimile and/or data communication capability; may include a PDA having a RF receiver and an internet/intranet access, web browser, notepad, calendar and/or global positioning system (GPS) receiver; and/or a conventional laptop and/or palm computer or other devices having a RF receiver. The “mobile terminal” used herein may refer to portable, transportable, fixed on a transportation (aviation, maritime and/or terrestrial) or suitable for and/or configured to run locally and/or run in the form of distribution on the earth and/or other places in the spaces. The “mobile terminal” used herein may also refer to a communication terminal, Internet terminal, music/video player terminal. The “mobile terminal” used herein may also refer to PDA, MID, and/or mobile phone with music/video playback capabilities etc. The “mobile terminal” as used herein may also be a smart TV, set-top box etc.

To achieve the object of the present invention, the present invention proposes to use existing capacitive touch sensors to lower the threshold of touch record, so that a floating touch event and a contact touch event can be distinguished, and with the support of an inner program, makes a response to the floating event to realize the floating operation of the terminal with indirect contact.

Briefly, the present invention proposes a touch operation processing method as follow:

S1, a terminal device detects a floating position of an operation object in a floating sensing area outside of a screen, and mapping the floating position to a corresponding position on the screen; and

S2, based on the type of an area where the corresponding position locates, the terminal device detects a floating touch operation of the operation object by adopting a way corresponding to the type of the area, and making a response to the floating touch operation accordingly.

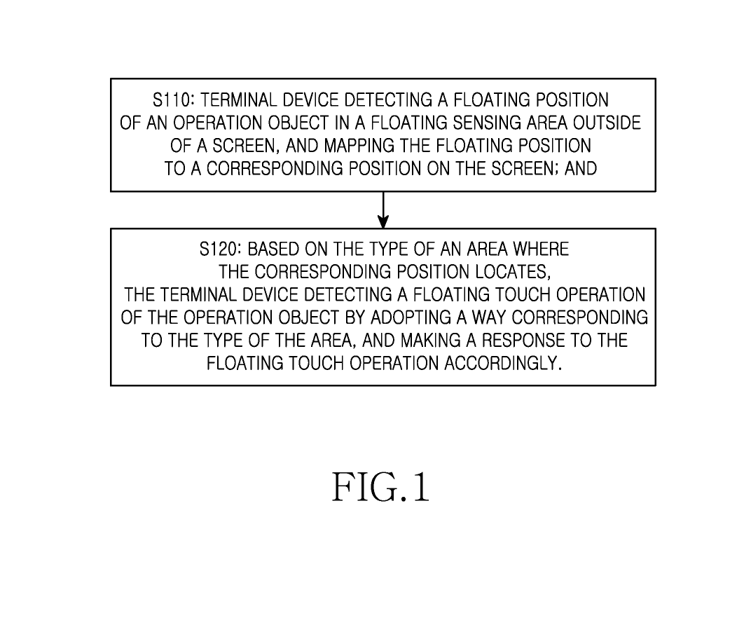

To be specific, as shown in FIG. 1, a flowchart showing the touch operation according to the embodiment of the present invention is shown.

As shown, in S110, the terminal device detects the floating position of the operation object in the floating sensing area outside of the screen, and maps the floating position to a corresponding position on the screen.

In step S110, when a terminal device detects floating motion of the operation object outside the screen, it will generate an electrode network that can be detected by the terminal device and when the user's touch range enters into the signal range, the terminal device will analyzes the user's floating touch operation using an inner program to generate a result corresponding to the user's floating touch operation, and then maps the current position of the operation object to a corresponding position on the screen.

Obviously, the way of mapping the current position of the operation object to the corresponding position on the screen includes but is not limited to vertical mapping. In addition, the “operation object” in the present invention is just a way of reference, and it should be understood that the operation object referred to in the technical solution of the present invention includes but is not limited to a user's finger, and it can be other parts of the user's body or other objects the electrode of which can be detected by the terminal device, e.g. stylus etc., which is intended scope of the present invention.

Specifically, the type of the area where the corresponding position on the screen locates includes but is not limited to a keyboard input area or a handwriting input area on the screen. For example, the corresponding position on the screen also includes a user self-defined area other than the keyboard input area and the handwriting input area, or an area specific for floating touch defined during the design of the terminal.

In the above, when the corresponding position on the screen is a keyboard input area, the terminal device adaptively adjusts the sizes of a key on the corresponding position and surrounding keys and displays them, or the terminal expands multiple characters on a single key and displays the multiple characters so as to facilitate the user's selection operation. For example, the selection can be done by contact selection or floating touch selection.

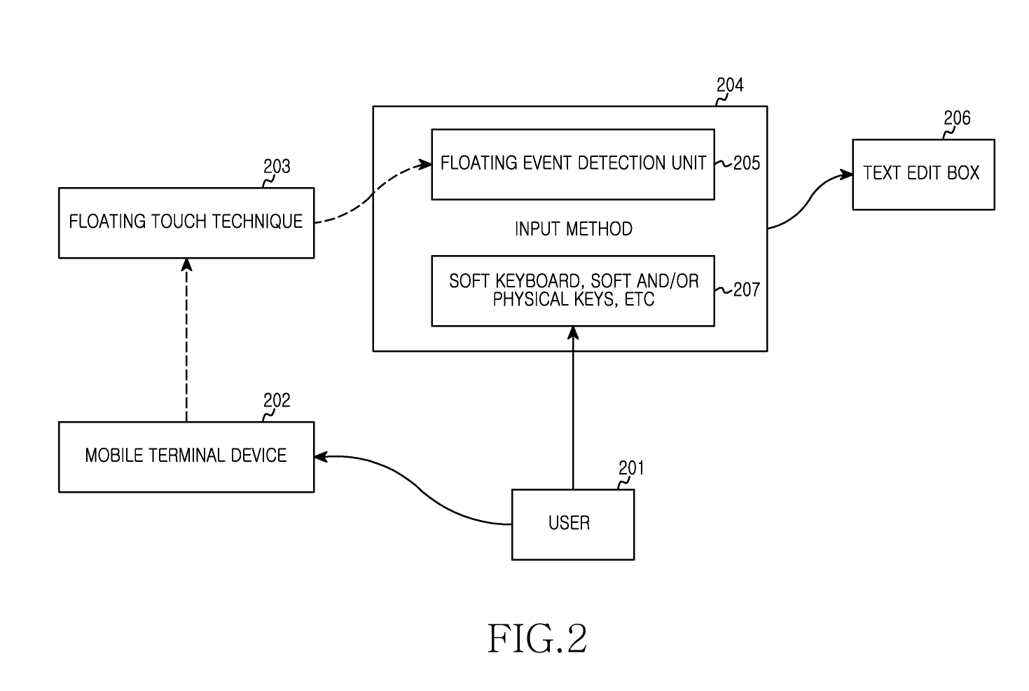

To be specific, the implementation of the technical solution of the present invention, for example as shown in FIG. 2, provides interactions of entities under input mode 204.

For example, when the user 201 manipulates the terminal device 202 by using the floating touch technique, the floating event detection unit 205 receives and analyzes data and actions of the floating manipulation by using the floating touch technique 203, and based on the returned result, adjusts the size of the local input method keyboard 207, the floating handwriting input, the expansion of characters on a single key, control of a cursor in a text edit box 206, edit operations such as deletion and selection of text, and self-defined gesture operations, etc.

Referring back to FIG. 1, in S120, based on the type of an area where the corresponding position locates, the terminal device detects a floating touch operation of an object in the corresponding area, and makes a response to the floating touch operation accordingly.

When the type of the area where the corresponding position on the screen locates is a keyboard input area, the terminal device adaptively adjusts the sizes of a key on the corresponding position on the screen and surrounding keys and display all the keys, or the terminal expands multiple characters on a single key and display them.

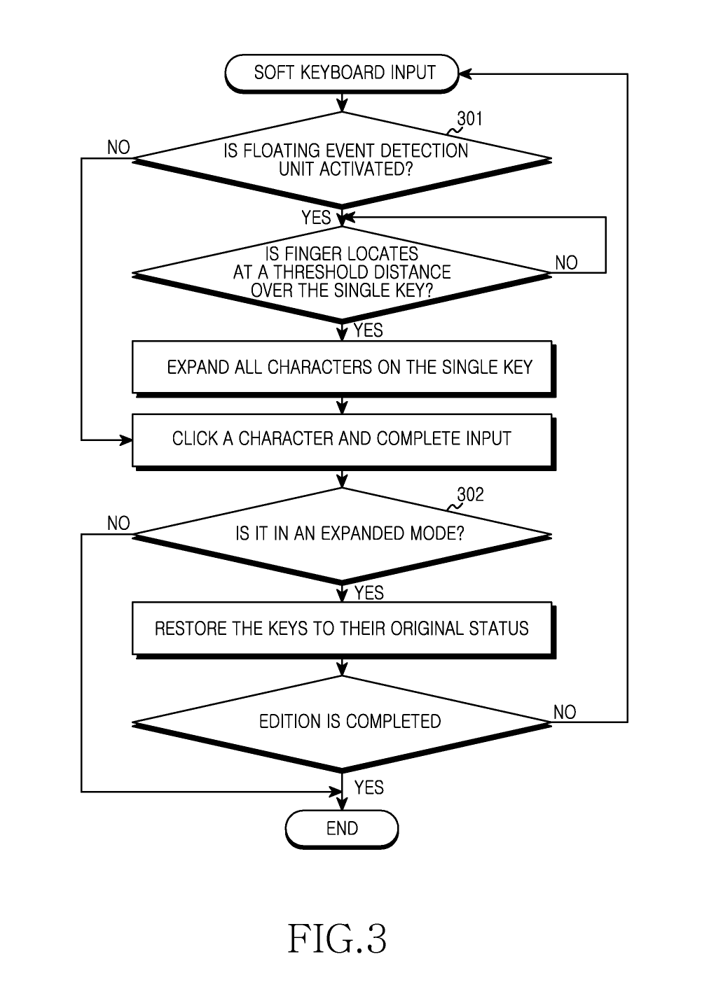

Specifically, for example, when the terminal device detects that the operation object clicks and selects a key displayed after its size being adaptively adjusted or a character on a single key that is expanded and displayed, it receives the selected key or character. And for example, when the terminal device detects that the user is performing floatingly writing using the floating touch, it will display the writing information on a corresponding position. Then, an input is detected and completed. Further for example, when the terminal device detects that the user is performing self-defined gesture control by using the floating touch, the terminal device will make an operation accordingly on a screen. The floating touch makes a corresponding position, for example a key button, to be expanding as an object such as a finger approaches a screen. Referring to FIG. 3, a control schematic diagram showing locally adaptively adjusting the size of the input method keyboard by floating touch described above is illustrated.

In operation, during an input using the soft keyboard to improve and enhance usability, the terminal in step 301 detects whether a floating event detection unit 205 is activated, and if it is not activated, a traditional contact touch input method is performed; and if it is activated, using the technical solution proposed by the present invention:

Detecting whether a finger floating around the keyboard area reaches a threshold distance from the screen, and if so, then the floating touch operation is realized and the keys on the keyboard area will be expanded, for example, a vertically mapped character or characters around it will all be locally expanded.

To be specific, for example, for a user using an all-letter QWERTY soft keyboard intending to input character “g”, when the user's finger approaches a vicinity area above the key “g”, other surrounding keys key “g” such as keys y, f, h, and b will all be expanded for the user to choose to input. By amplifying the local keys, even a user with poor sight can see the larger key buttons to complete the input of a character.

Thereafter, step 302 is entered to determine whether the screen is in an expanded mode, and if it is, then the original size is restored and waits for a next input.

In an alternate embodiment, a control switch can be provided for presetting interface for the user during an input mode. For example, at step 301, based in a control switch value, the terminal may activate a floating event detection module which in turn causes the keyboard to expand and detect a near touch operation within a certain distance, for example 5 mm, from the terminal touch screen. After a click operation is detected and completed, at step 302, it is determine whether the keyboard keys are in an expanded mode, and if so, the expanded keyboard is restored to an original size and waits for a next input. Further, multiple characters on a single key can be further expanded and displayed when using the floating touch as described earlier.

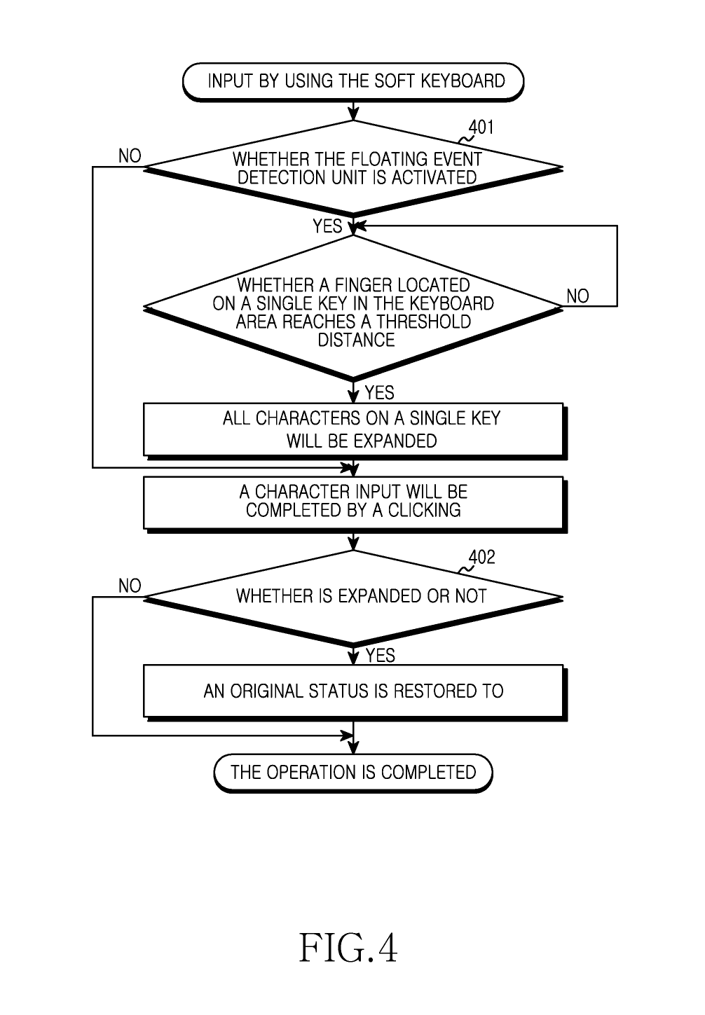

FIG. 4 is a schematic diagram showing expanding and displaying multiple characters on a single key as described above.

As shown, when an input using the soft keyboard occurs to improve usability in step 401, the terminal determines whether a floating event detection unit is activated, and if not, a traditional contact touch input method will be used.

If the floating event detection unit is activate, the terminal determines whether a finger near the keyboard area reaches a threshold distance, and if so, then the floating touch operation is realized and all characters on a single key will be expanded, so that a character input will be completed after a floating touch click operation or a contact touch click operation. Thereafter, an original status is restored to and the operation is completed.

To be specific, for example, for a user using 3*4 soft keyboard who intends to input character “x”, when the user's finger approaches an area over the key “wxyz”, the key “wxyz” is expanded so that the user may easily choose“w” “x” “y” “z” to input, and the user can complete the input by simply click the key “x”. To be specific, when an input occurs in a handwriting input area of the screen, the terminal device detects the floating writing operation by an object in the hand-writing input area and displays information corresponding to the recognized floating writing or selection.

In the above, the terminal device displaying information of the floating writing and associated information comprises but is not limited to any of the following ways:

When the object relating to a floating operation pertaining to a letter input is detected, the terminal displays a letter after converting it from upper case to lower case;

When the floating operation relates to writing a Chinese character is detected, the displayed associated information includes piled Chinese characters after converting the Chinese character from a single character into piled characters, or a complex Chinese character after converting the Chinese character from a simple Chinese character to a complex Chinese character, or another Chinese character whose radical is the Chinese character;

When the floating operation relates to writing a number is detected, the displayed associated information includes information of converting the number into a number with multiple digits;

When the floating operation relates to writing information is detected, the displayed associated information includes information that is translated into a predefined language, or information of original chirography being kept; and

When the floating operation relates to writing a Chinese character is detected, the displayed associated information includes the Pinyin of the Chinese character.

The terminal device further includes: performing an edit processing and/or self-defined gesture control for the presetting contents based on the user's selection and the detected floating touch operation of the object. That is, the terminal performs an edit operation during a handwriting input mode.

In the above, detecting the floating touch operation of the operation object and performing self-defined gesture control comprises but is not limited to any of the following ways:

When the floating operation relates to drawing a straight line towards left or right at an accelerated speed is detected, characters on the left or on the right of a cursor will be deleted;

When the floating operation relates to drawing “ [symbol] ” sequentially from up to left direction is detected, the cursor will be put to a next line;

When the floating operation relates to drawing “|” sequentially from top down is detected, the type of the keyboard is switched; and

When the floating operation relates to drawing a shape of “ [symbol] ” is detected, an input method keyboard will be hidden.

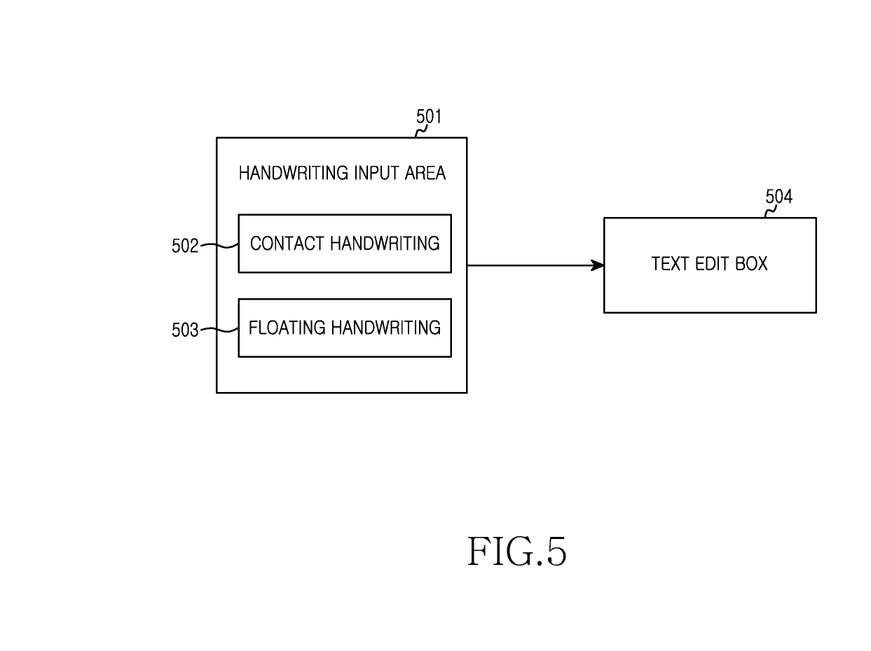

Referring to FIG. 5 which shows a schematic diagram showing interactions of entities during an edit mode, when performing handwriting input in the handwriting input area 501, the terminal device can receive two kinds of handwriting input modes, i.e. contact handwriting input 502 and floating handwriting input 503, at the same time. The handwriting results will be submitted to the text edit box 504. Here, the distance of the finger manipulation above the handwriting area should be less than 20 mm.

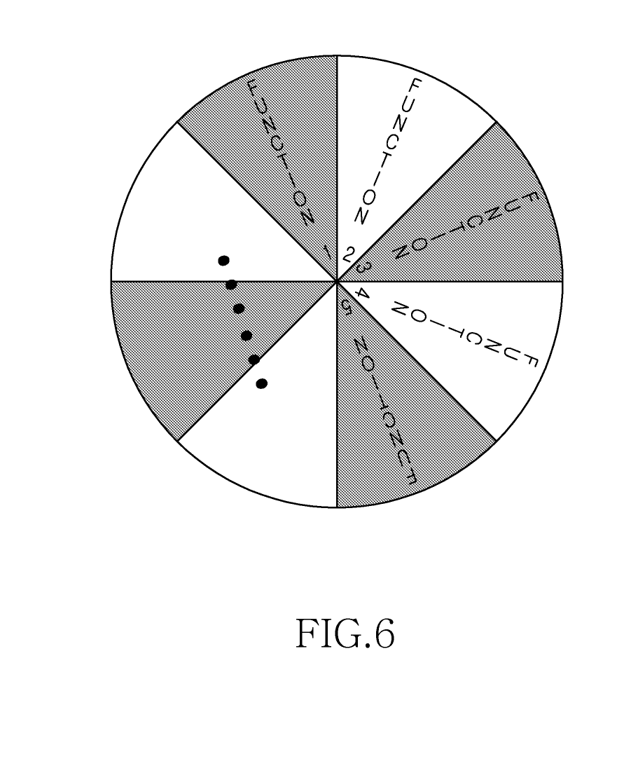

In an alternate embodiment, as shown in FIG. 6, is the terminal may customize or preprogram different functions corresponding to different floating touch operations according to a user's preference.

As shown, function 1, function 2, function 3, function 4, and function 5 in the drawing represents different operation functions, the details of which will be explained by the embodiments hereafter. For example, the functions in these embodiments can be selected or be canceled; when the following embodiment are to be implemented, corresponding functions will be selected; and when there are some conflicts among these functions of the embodiment, then disabled function is used to implement selection at different times. Here are the examples:

Function 1: floating handwriting is used to interconvert English letters, words or sentences from upper case to lower case or from lower case to upper case. For example, when write letter “a” by hand contact, the first candidate letter is “a”; for the same trace floating handwriting, the first candidate letter is capital letter “A”. The English letter's floating handwriting input is changed from lower case to upper case or from upper case to lower case: when floatingly write word “name” with his hand, the first candidate word for user's choice is “NAME” etc. That is, a lower letter and a capital letter may be selected according to the hand contact and the floating handwriting.

Function 2: floating handwriting input of a piled Chinese character by converting a single Chinese character into a piled Chinese character. For example, when Chinese character “ [symbol] ” is input by hand contact, the same trace floating handwriting let the candidate characters such as “ [symbol] ”, “ [symbol] ”, “ [symbol] ”, etc., are displayed.

Function 3: floating handwriting input of a general Chinese character (not piled) by converting a simple Chinese character into a complex Chinese character, i.e. “write simple to get complex”. For example, when write Chinese character “ [symbol] ” by hand contact, the first candidate character is “ [symbol] ”. By the way, for the same trace floating handwriting, the first candidate is “ [symbol] ”, etc. Furthermore, the floating handwriting “write complex to get simple” can also be defined vice verse.

Function 4: floatingly write a number with hand and convert this single number into a number with multiple digits. For example, when write number “9” by hand contact, the first candidate character is “9”. By the way, for the same trace floating handwriting, the candidates are “99”, “999”, “9999”, etc.

Function 5: floatingly write a number and convert it to a Chinese capital character or other numeric characters related to the number. For example, when floatingly write number “4” with his hand, candidate characters “ [symbol] ” “IV” “four” “ [symbol] ” etc. will appear.

Function 6: floating handwriting input of emoticons. For example, when an emoticon (^{—}∇^{—}) is written by traditional hand contact, the terminal will recognize it as a Chinese character, English or punctuation symbol to process. By the way, for the same trace floating handwriting, the terminal will recognize it as an emoticon to input and process it. Function 7: floating handwriting is used for inter conversion between Chinese characters and Pinyin. For example, when a user floatingly writes “ [symbol] ” with his hand, the first candidate is “mei (with a second tone)”; and if the user floatingly writes “mei” with his hand, then the candidate characters are Chinese characters with their pronunciation all being “mei”. Function 8: floating handwriting to get translation input. For example, when Chinese character “ [symbol] ” is written by the traditional hand contact, the first candidate is “ [symbol] ”; for the same trace floating handwriting, the first candidate is English “umbrella”. Obviously, the target languages that can be translated into can be set to other languages by user's presetting. Function 9: floatingly input an original chirography. In some edit boxes supporting original chirography input, the original chirography can be input directly and floatingly; for example, in this kind of edit boxes, when a certain character is input by traditional contact handwriting, the terminal will recognize it as a standard character such as a Chinese character, English or punctuation symbol and process it; accordingly, when the input is floating handwriting, the terminal will input the original trace of the character, i.e. the trace of floating handwriting. The graph shown in FIG. 6 displays the function items for the user for selection.

Obviously, the above are just examples to illustrate floating writing by using floating touch, however, the present invention includes but is not limited to the functions defined above, and it should be understood that all objects realized by floating writing by using floating touch should belong to the scope of the present invention.

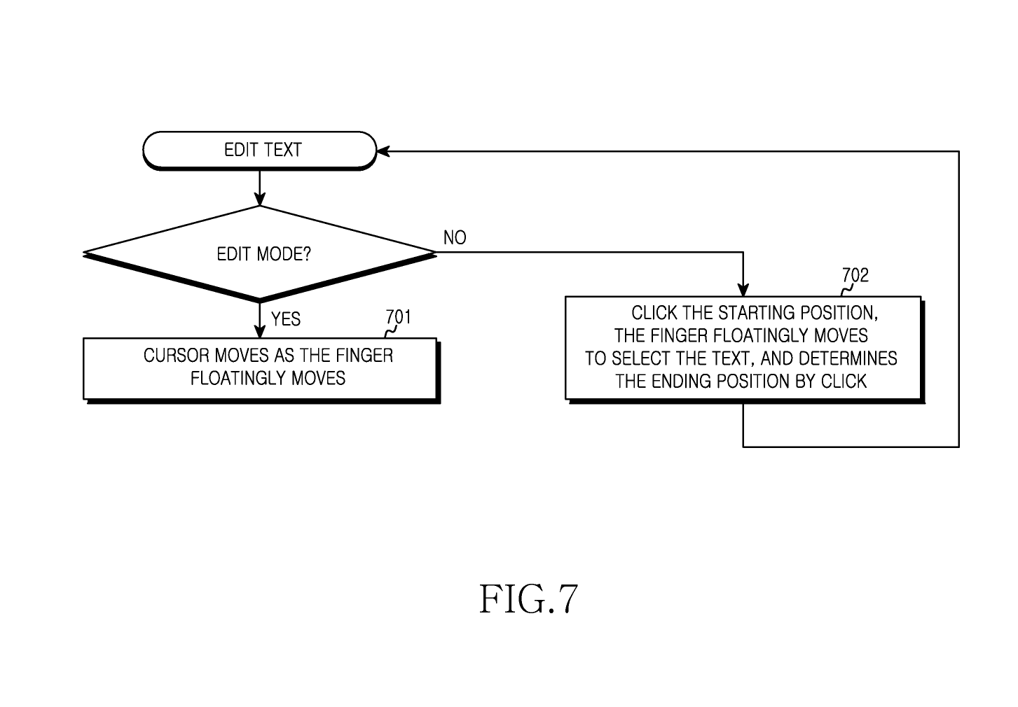

FIG. 7 is a schematic diagram showing the edit processing realized by the floating touch. If text is in edit mode, then the position of the cursor will be controlled at 701: the cursor moves as the finger floatingly moves; if it is not in the edit mode, then the text selection function will be performed at 702: click the starting position, the finger floatingly moves to select the text, and determines the ending position by click. Clicking a starting position and the moving over the screen (i.e., floatingly moving) without touching the screen, and then touching the end of a text may select a sentence block.

The above are just examples illustrating using floating touch to edit and control the cursor, however, the present invention includes but is not limited to the above defined functions, and it should be understood that all objects realized by using the floating touch to edit and to control the cursor should belong to the protection scope of the present invention.

In addition, operations that need to be realized by floating touch are defined according to the user's requirements; for example, define a certain function for a certain gesture, which is illustrated as follows:

a) when the finger floatingly touches the keyboard area and draws a straight line towards left (right) rapidly, characters on the left or (right) of the cursor will be deleted;

b) when the finger floatingly touches the keyboard area and draws “ [symbol] ” sequentially from up to left, the cursor will be put to a next line;

c) when the finger floatingly touches the keyboard area and draws “|” sequentially from top down, the type of the keyboard is switched; and

d) the user can define a floating gesture by himself to carry out a certain corresponding action; for example, the user defines that the effect of drawing a shape of “ [symbol] ” by floating touch is hiding the input method keyboard.

The above are examples illustrating defining gesture operations by using floating touch, and the present invention includes but is not limited to the functions defined above, and it should be understood that all objects realized by self-defined gestures by floating touch should belong to the scope of the present invention.

The method proposed above by the present invention, by introducing floating touch technique during the user's input, provides a variety of choices for user input operation. Furthermore, according to the technical solution proposed by the present invention, manipulation functions corresponding to the floating touch operations can be defined according to the user's requirements, which makes the user's input operation be more efficient and convenient and brings totally new edit and input experiences to the user.

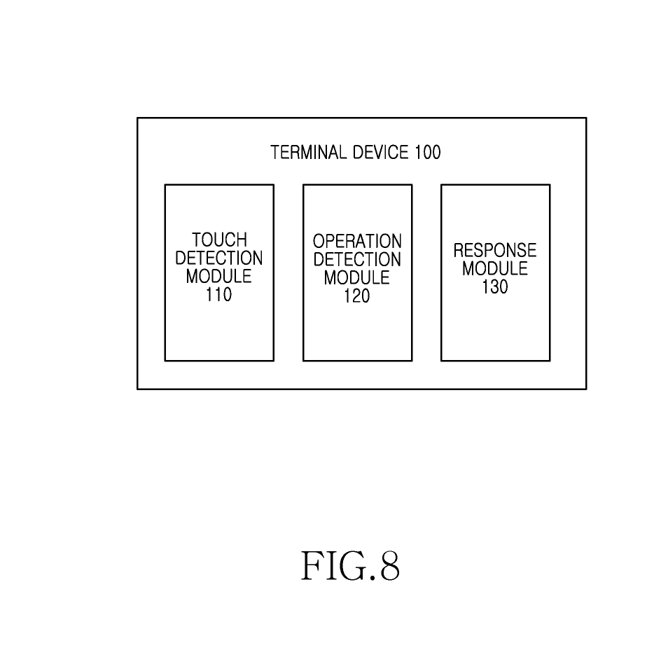

Another aspect of the embodiments of the present invention proposes a terminal device, as shown in FIG. 8, which a schematic diagram showing the structure of the terminal device 100. As shown, the terminal may include a touch detection module 110, an operation detection module 120, and a response module 130.

In operation, the touch detection module 110 is configured to detect the floating position of the operation object in the floating sensing area outside of the screen and map the floating position to a corresponding position on the screen.

The operation detection module 120 is configured to, based on the type of an area where the corresponding position locates, detects floating touch operations of the operation object by adopting a way corresponding to the type of the area.

The response module 130 is configured to make responses to the floating touch operations accordingly.

As an embodiment of the above device 100, the corresponding position on the screen mapped by the touch detection module 110 includes:

a keyboard input area or handwriting input area on the screen.

As an embodiment of the device 100, when the type of the area where the corresponding area on the screen locates is a keyboard input area, the response module 130 is also configured to adaptively adjust the sizes of a key on the corresponding position and surrounding keys and display them, or expand multiple characters on a single key and display them so as to facilitate the operation object's selection operation.

As an embodiment of the above device 100, operation detection module 120 is also configured to detect that the operation object clicks a key after its size being adaptively adjusted, or when characters on a single key are expanded to display, to receive a selected key or character.

As an embodiment of the device 100, in the case that the type of the area where the corresponding position on the screen locates is a handwriting input area, when the operation object detection module 120 detects that the operation object is floatingly writing in the handwriting input area, the response module 130 is also configured to display information floatingly written and associated information.

As an embodiment of the device 100, a response module 130 being configured to display information of floating writing and associated information includes any of the following methods: when the operation object floatingly writing a letter is detected, the displayed associated information includes the letter after conversion it from upper case to lower case; when the operation detection module 120 detects that the operation object is floatingly writing a Chinese character, the associated information displayed by the response module 130 includes piled Chinese characters after conversion the Chinese character from a single character into a piled character, or a complex Chinese character after conversion the Chinese character from a simple Chinese character to a complex Chinese character, or another Chinese character whose radical is the Chinese character; when the operation detection module120 detects that the operation object is floatingly writes a number, the associated information displayed by the response module 130 includes information of converting the number into a number of multiple digits; when the operation detection module 120 detects that the operation object is floatingly writing information, the associated information displayed by the response module 130 includes information that is translated into a predefined language, or the information of the original chirography is kept; and when the operation detection module 120 detects that the operation object is floatingly writes a Chinese character, the associated information displayed by the response module 130 includes the Pinyin of the Chinese character.

As an embodiment of the above device 100, the operation detection module 120 is also configured to perform edit processing and/or perform self-defined gesture control for the presetting contents based on the user's selection and the detected floating touch operation of the operation object. When the corresponding position on the screen is a handwriting input area, the operation detect module 120 detects the floating touch operation of the operation object and perform edit processing.

As an embodiment of device 100, the operation detect module 120 being configured to detect the floating touch operation of the operation object and performing self-defined gesture control includes but is not limited to any of the following methods: when the operation detection module 120 detects that the operation object draws a straight line towards left or right at an accelerated speed by floating touch, the response module 130 deletes characters on the left or on the right of the cursor; when the operation detection module 120 detects that the operation object draws “ [symbol] ” sequentially from up to left by floating touch, the response module 130 will put the cursor to a next line; when the operation detection module 120 detects that the operation object draws “|” sequentially from top down by floating touch, the response module 130 will switch the type of the keyboard; and when the operation detection module 120 detects that the operation object draws a shape of “ [symbol] ” by floating touch, the response module 130 will hide the input method keyboard. The above device provided by the present invention, by introducing floating touch technique during the user's input, provides the user input operation with a variety of choices.

Furthermore, according to the technical solution proposed by the present invention, manipulation functions corresponding to the floating touch operations can be defined according to the user's requirements, which enables the user's input operation be more efficient and convenient and brings totally new edit and input experiences to the user. It can be understood by those skilled in the art that the present invention can relate to a device executing one or several of the operations in the present invention. The device can be designed and manufactured for intended purpose, or comprises known devices in a general computer, the general computer being activated or reconstructed selectively by programs stored therein. These computer programs can be stored on device (e.g. computer) readable storage medium or stored in any type of media that are suitable for storing electronic instructions and are coupled to the bus, the computer readable media including, but not limited to any type of disk (including floppy disk, hard disk, CD, CD-ROM and magnet disk), RAM, ROM, EPROM, EPROM, EEPROM, flash, magnet card, or light card. The readable media comprise any mechanism that stores or transmits information by way of being device (computer) readable. For example, a computer-readable medium includes RAM, ROM, magnet storage medium, optical storage medium, flash, signals transmitted by electricity, optical storage media, flash, and transmitting signals in the form of electricity, light, sound or others (e.g. carrier wave, infrared signal, digital signal), and the like.

It can be understood by those skilled in the art that the present invention have been described with reference to the structural diagrams and/or blocks and/or flowcharts of methods, systems, and computer programming products of the implementation of the present invention. It should be understood that each block in the structural diagrams and/or blocks and/or flowcharts or blocks combinations in these structural diagrams and/or blocks and/or flowcharts or blocks can be implemented by using computer programming instructions. These computer programming instructions can be provided to a general purpose computer, a specialized computer or other processors of programmable data processing methods to generate the machine, so that the instructions executed by a computer or processors of other programmable data processing methods to create the methods indicated by the boxes in the structural diagrams and/or block diagrams and/or flowcharts.

It can be understood by those skilled in the art that these computer programming instructions may also be loaded into a computer or other programmable data processing methods to make a sequence of operation steps can be executed on the computer or other programmable data processing methods to generate processes that can be implemented by the computer; thus the instructions executed on the computer or other programmable data processing methods provide steps for implementing steps indicated in the box or boxes in the structural diagrams and/or block diagrams and/or flowcharts. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

It can be understood by those skilled in the art that the steps, measures, schemes in the various operations, methods and flowcharts that have been discussed can be alternated, changed, combined or deleted. Furthermore, other steps, measures, schemes having the various operations, methods and flowcharts that have been discussed can also be alternated, changed, rearranged, decomposed, combined or deleted. Furthermore, the steps, measures, and schemes in the traditional art or in the present invention can be alternated, changed, rearranged, decomposed, combined or deleted.

The exemplary implementations are disclosed in the accompanying drawings and the specification. Though certain terminologies are used herein for general and description usage purpose, and should not be constructed as limiting. It should be pointed out that for those ordinary skilled in the art, various modifications and improvements can be made without departing from the principle of the invention, and those modifications and improvements should be deemed as in the scope of the present invention. The protecting scope of the present invention should be defined by the claims of the present invention.

What is claimed is:

1. A touch operation processing method in a portable terminal, comprising:
detecting a floating position of an object near a floating sensing area of a screen;
mapping the detected floating position to a corresponding position on the screen; and
adjusting an appearance of an area corresponding to the mapped position displayed on the screen in response to the object nearing thereto.

2. The method according to claim 1, wherein the area corresponding the mapped position on the screen includes: a keyboard input area or handwriting input area.

3. The method according to claim 2, when the area corresponding the mapped position on the screen is the keyboard input area, the terminal expands the size of a specific key on the on the screen and adjacent keys.

4. The method according to claim 2, when the area corresponding the mapped position on the screen is the keyboard input area, the terminal displays multiple characters assigned to a single key individually.

5. The method according to claim 2, when the area corresponding the mapped position on the screen position on the screen is a handwriting input area,
the terminal detects a floating operation of the object in the handwriting input area and displaying information associated with the floating operation.

6. The method according to claim 5, wherein the terminal device performs at least one of:
when the floating operation of writing a letter is detected, the displayed information includes the letter after converting it from an upper case to a lower case;
when the floating operation of writing a Chinese character is detected, the displayed information includes piled Chinese characters after converting the Chinese character from a single character into the piled Chinese characters, or a complex Chinese character after converting the Chinese character from a simple Chinese character to a complex Chinese character, or another Chinese character whose radical is the Chinese character;
when the floating operation of writing a number is detected, the displayed information includes the number converted into a number with multiple digits;
when the floating operation of writing information is detected, the displayed information includes information that is translated into a predefined language or original chirography; and
when the floating operation of writing a Chinese character is detected, the displayed information includes the Pinyin of the Chinese character.

7. The method according to claim 1, further comprising performing an edit operation based on a user's selection.

8. The method according to claim 1, wherein detecting the floating operation of the comprises at least one of:
when the floating operation of drawing a straight line from left or right direction is detected, deleting characters between the left or on the right of the straight line
when the floating operation of drawing “ [symbol] ” sequentially from top to left is detected, moving a cursor in a next line;
when the floating operation of drawing “|” sequentially from top to bottom is detected, switching to another keyboard; and
when the floating operation of drawing a shape of “ [symbol] ” is detected, hiding an input method keyboard.

9. A terminal device for providing a touch operation comprising
a touch screen configured to detect a floating operation of an object near a floating sensing area of the touchscreen and map the detected floating position to a corresponding position thereon; and
a controller controlling the touch screen to adjust at least one key displayed on the screen in response to the operation object nears thereto.

10. The terminal device according to claim 9, wherein an area corresponding the mapped position on the touch screen includes:
a keyboard input area or handwriting input area.

11. The terminal device according to claim 10, when the area corresponding the mapped position on the screen is the keyboard input area, the terminal expands the size of a specific key on the on the screen and adjacent keys.

12. The terminal device according to claim 10, when the area corresponding the mapped position on the screen is the keyboard input area, the terminal displays multiple characters assigned to a single key individually.

13. The terminal device according to claim 10, when the area corresponding the mapped position on the screen position on the screen is a handwriting input area, the terminal device detects a floating operation of the object in the handwriting input area and displaying information associated with the floating operation.

14. The terminal device according to claim 13, wherein the controller further controls the touch screen to perform at least one of:
when the floating operation of writing a letter is detected, display information including the letter after converting it from an upper case to a lower case;
when the floating operation of writing a Chinese character is detected, display information including piled Chinese characters after converting the Chinese character from a single character into the piled Chinese characters, or a complex Chinese character after converting the Chinese character from a simple Chinese character to a complex Chinese character, or another Chinese character whose radical is the Chinese character;
when the floating operation of writing a number is detected, display information including the number converted into a number with multiple digits;
when the floating operation of writing information is detected, the display information that is translated into a predefined language or original chirography; and
when the floating operation of writing a Chinese character is detected, display information includes the Pinyin of the Chinese character.

15. The terminal device according to claim 9, wherein the controller further performs an edit operation based on a user's selection.

16. The terminal device according to claim 15, wherein the controller further configured to detect the floating operation comprises performing at least one of:
when the floating operation of drawing a straight line from left or right direction is detected, delete characters between the left or on the right of the straight line
when the floating operation of drawing “ [symbol] ” sequentially from top to left is detected, move a cursor in a next line;
when the floating operation of drawing “|” sequentially from top to bottom is detected, switch to another keyboard; and
when the floating operation of drawing a shape of “ [symbol] ” is detected, hide an input method keyboard.
